(19) United States
(12) Patent Application Publication
(10) Pub. No.: US 2024/0059845 A1
(43) Pub. Date: Feb. 22, 2024

(54) POLYMERIC MICROPARTICLE COMPOSITIONS

(71) Applicant: Interfacial Consultants LLC, Prescott, WI (US)

(72) Inventors: Jeffrey Jacob Cernohous, Hudson, WI (US); Paul Edward Humpal, Stillwater, MN (US); Ellis Clark Johnson, Hudson, WI (US); Meghan Corinne Huey, Woodbury, MN (US)

(21) Appl. No.: 18/270,373

(22) PCT Filed: Dec. 28, 2021
(86) PCT No.: PCT/US2021/065286

§ 371 Date: Jun. 29, 2023

Related U.S. Application Data
(60) Provisional application No. 63/132,449, filed on Dec. 30, 2020.

(51) Int. Cl. C08J 3/12; B33Y 70/00

(52) U.S. Cl. CPC C08J 3/126; B33Y 70/00; B29K 2105/251

(57) ABSTRACT

A method for producing polymeric microparticle compositions using the steps of: 1) melt processing an immiscible polymeric blend comprising an immiscible polymer matrix and a soluble polymer matrix, 2) dissolving the soluble polymer matrix of the immiscible polymeric blend using a solvent to yield a polymeric microparticle composition, and 3) isolating the polymeric microparticle composition.

### CROSS-REFERENCE TO RELATED APPLICATION

This application claims priority to U.S. Provisional Application No. 63/132,449 filed Dec. 30, 2020, which is hereby incorporated by reference.

### TECHNICAL FIELD

This disclosure relates to compositions and methods for producing polymeric microparticle compositions using the steps of: 1) melt processing an immiscible polymeric blend comprising an immiscible polymer matrix and a soluble polymer matrix, 2) dissolving the soluble polymer matrix of the immiscible polymeric blend using a solvent to yield a polymeric microparticle composition, and 3) isolating the polymeric microparticle composition. The resulting polymeric microparticle compositions have utility in many applications including but not limited to, additive manufacturing feedstocks (e.g., selective laser sintering) and additives for paints and coatings, plastics and cosmetics.

### BACKGROUND

Polymeric microparticle compositions have utility in many commercial applications. Each respective application has specific requirements for the microparticle products. These may include polymer composition, particle size, particle size distribution (PSD), and shape. In the additive manufacturing industry, polymeric microparticle compositions are used as feedstocks for selective laser sintering (SLS) and electrophotographic processes. In SLS, it is desirable to have spherical microparticles that have a number average particle size of approximately 50 microns, this in large part enables proper flow and uniform sintering. In paints and coatings, they are often used to impart optical attributes (e.g., matte surface appearance) or flow attributes. In this instance, it is common for the particles to be in the 5 to 20 micron range. Polymeric microparticle compositions are often used in plastic film additives to impart anti-blocking performance. In this instance, the particles are typically in the 5 to 50 micron range. In many applications, spherical microparticle morphology is desirable. In others, an ellipsoidal microparticle morphology may be desirable. Some applications require a very tight particle size distribution while others benefit from a broad or multimodal particle size distribution. As is apparent, each application requires specific particle size, composition and distribution.

Polymeric microparticle compositions today are primarily produced using three methods. The first method is by direct emulsion or suspension polymerization of the material. This method allows one to control the size and distribution of the particles but is only applicable to a narrow range of materials, primarily free radically polymerizable monomers, such as methyl methacrylate. The second method to produce polymeric microparticle compositions is called precipitation. In this method, a polymer is dissolved in a solvent and a poor second solvent is added until the polymer crashes out of solution to yield a microparticle. This method does not offer precise particle size control and is limited to polymers that can be easily dissolved in a solvent. The final method is mechanical grinding. In this method, a polymeric material is mechanically milled to a desired particle size. This method is limited to materials that are brittle under the process conditions and typically produces particles with irregular shape and poor particle size distribution.

A process that allows one to control all desired attributes and that can be utilized for a wide variety of polymeric materials is highly desirable but does not exist. The process for producing polymeric microparticle compositions of this disclosure offers a solution to this problem. We have achieved this by using a strategy that relies on melt processing two immiscible polymeric materials and subsequently removing one of these materials with a solvent to yield a polymeric microparticle composition. The particle size and shape are controlled by manipulating certain attributes of each melt processible immiscible polymeric material, including melt viscosity/rheology, interfacial tension, and melt processing conditions. In doing so, we have created a method that is capable of producing a wide range of polymeric microparticle compositions with a high level of control. This disclosure describes compositions and methods for producing polymeric microparticle compositions using the steps of: 1) melt processing an immiscible polymeric blend comprising an immiscible polymer matrix and a soluble polymer matrix, 2) dissolving the soluble polymer matrix of the immiscible polymeric blend using a solvent to yield a polymeric microparticle composition, and 3) isolating the polymeric microparticle composition.

### SUMMARY

As previously mentioned, polymeric microparticle compositions are found to have significant industrial utility. However, the number of polymeric materials available in microparticle form are limited as a result of capabilities of the manufacturing methods known in the art today. The method of this disclosure provides a universal method for producing polymeric microparticle compositions from nearly any polymer, polymer blend, or polymer composite. This disclosure describes compositions and methods for producing polymeric microparticle compositions using the steps of: 1) melt processing an immiscible polymeric blend comprising an immiscible polymer matrix and a soluble polymer matrix, 2) dissolving the soluble polymer matrix of the immiscible polymeric blend using a solvent to yield a polymeric microparticle composition, and 3) isolating the polymeric microparticle composition. The resulting polymeric microparticle compositions have utility in many applications including but not limited to, additive manufacturing feedstocks (e.g., selective laser sintering) and additives for paints and coatings, plastics and cosmetics.

Accordingly, in one embodiment, the immiscible polymeric blend is melt-processed, isolated, and treated with a solvent to remove the soluble polymer matrix. Once the soluble polymer matrix is dissolved, it can be separated from the polymeric microparticle composition. In some embodiments, the solvent used to dissolve the soluble polymer matrix is an organic solvent, in other embodiments, the solvent used is water. In another embodiment, the solvent used is a supercritical gas (e.g., supercritical carbon dioxide). In another embodiment, the solvent used is a combination of a supercritical gas and an organic solvent or water.

In one embodiment, the polymeric microparticle composition is isolated from the solvated soluble polymer matrix via gravity or settling. In another embodiment, the polymeric microparticle composition is isolated from the soluble polymer matrix by centrifugation. In another embodiment, the polymeric microparticle composition is isolated from the soluble polymer matrix via filtration. In one embodiment, the polymeric microparticle composition isolate is subsequently washed multiple times with a solvent. In yet another embodiment, the residual soluble polymer matrix of the polymeric microparticle composition is less than 0.1 weight percent. In other embodiments, the residual soluble polymer matrix of the polymeric microparticle composition is less than 0.01 weight percent.

In one embodiment, the isolated polymeric microparticle composition is dried at an elevated temperature to remove residual solvent. In another embodiment, the isolated polymeric microparticle composition is dried under vacuum. In yet another embodiment, the isolated polymeric microparticle composition is dried at an elevated temperature and under vacuum.

The above summary is not intended to describe each disclosed embodiment or every implementation. The detailed description that follows more particularly exemplifies illustrative embodiments.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, an immiscible polymeric blend containing “an” immiscible polymer matrix means that the immiscible polymeric blend may include “one or more” immiscible polymer matrices.

The terms “additive manufacturing,” “three-dimensional printing,” or “3D printing” refer to any process used to create a three-dimensional object in which successive layers of material are formed under computer control (e.g., electron beam melting (EBM), fused deposition modeling (FDM), ink jetting, laminated object manufacturing (LOM), selective laser sintering (SLS), and stereolithography (SL)).

The term “amorphous” refers to a polymeric microparticle composition with crystallinity less than 5% as measured by differential scanning calorimetry (DSC).

The term “crystalline” refers to a polymeric microparticle composition with crystallinity greater than 90% as measured by differential scanning calorimetry (DSC).

The term “feedstock” refers to the form of a material that can be utilized in an additive manufacturing process (e.g., as a build material or soluble support). Non-limiting feedstock examples include, but are not limited to, pellets, powders, filaments, billets, liquids, sheets, shaped profiles, etc.

The term “immiscible polymer matrix” means a melt processible polymer that is less than 50 volume % of the immiscible polymeric blend and is substantially insoluble (solubility<1 g/L) in a solvent that dissolves or disintegrates the soluble polymer matrix.

The term “immiscible polymeric blend” means a melt processible composition of an immiscible polymer matrix and a soluble polymer matrix.

The term “melt processing technique” means a technique for applying thermal and mechanical energy to reshape, blend, mix, or otherwise reform a polymer or composition, such as compounding, extrusion, injection molding, blow molding, roto molding, or batch mixing. For the purposes of clarity, 3D printing processes that are useful in printing thermoplastic and elastomeric melt processable materials are examples of a melt processing technique.

The term “melt processing temperature” refers to a temperature above the glass transition temperature for an amorphous polymer or a temperature above the glass transition and melting temperatures for a semi-crystalline or crystalline polymer using a melt processing technique.

The term “microparticle morphology” refers to a composition produced by melt processing an immiscible polymer matrix and a soluble polymer matrix where the immiscible polymer matrix has spherical or ellipsoidal morphology with a number average particle size of less than 100 microns and an average aspect ratio of less than 2:1 (length:diameter).

The term “non-equilibrium microparticle morphology” means a blend morphology that has been kinetically trapped in a non-equilibrium state, that when heated above the melt processing temperature of the polymeric microparticle composition results in a visual morphological change (e.g., blend coalescence, aspect ratio change, etc.).

The terms “polymer” and “polymeric” mean a molecule of high relative molecular mass, the structure of which essentially contains multiple repetitions of units derived, actually or conceptually, from molecules of low relative molecular mass.

The term “polymeric microparticle” means a polymeric material that has a microparticle morphology.

The term “polymeric microparticle composition” refers to a composition of polymeric microparticles that optionally include additives, fillers, or additional polymers.

The term “semi-crystalline” refers to a polymeric microparticle composition with crystallinity greater than 5% but less than 90% as measured by differential scanning calorimetry (DSC).

The term “soluble polymer matrix” means a melt processible polymer that is soluble in a solvent that has little to no ability to dissolve the immiscible polymer matrix of the immiscible polymeric blend. The soluble polymer matrix is greater than 50 volume % of the immiscible polymeric blend.

The recitation of numerical ranges using endpoints includes all numbers subsumed within that range (e.g., 1 to 5 includes 1, 1.5, 3, 3.95, 4.2, 5, etc.).

This disclosure describes compositions and methods for producing polymeric microparticle compositions using the steps of: 1) melt processing an immiscible polymeric blend comprising an immiscible polymer matrix and a soluble polymer matrix, 2) dissolving the soluble polymer matrix of the immiscible polymeric blend using a solvent to yield a polymeric microparticle composition, and 3) isolating the polymeric microparticle composition. Such polymeric microparticle compositions have utility in many markets including additive manufacturing, coatings, adhesives, sealants, plastic films and cosmetics.

A variety of immiscible polymer matrices can be melt processed with the soluble polymer matrix to create an immiscible polymeric blend. Non-limiting examples of immiscible polymer matrices that can be used to make such a blend include high density polyethylene (HDPE), low density polyethylene (LDPE), linear low density polyethylene (LLDPE), crosslinked polyethylene (PEX), vulcanized rubber, functional polyolefin copolymers including polyolefin based ionomers, polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyetheretherketones, polyketones, polyacetals, polycarbonates, polyphenylene oxides, polyurethanes, thermoplastic elastomers (e.g., SIS, SEBS, SBS), silicones, or combinations thereof. Additives, such as those disclosed herein, may optionally be included as well.

The soluble polymer matrix of this disclosure may dissolve or disintegrate when exposed to a solvent such that it is easy to remove the soluble polymer matrix from the immiscible polymeric blend. The soluble polymer matrix of this disclosure must also be immiscible with the immiscible polymer matrix such that the immiscible polymer matrix forms discreet microparticle domains within the soluble polymer matrix. Non-limiting examples of soluble polymer matrices that can be used to make such a blend include high density polyethylene (HDPE), low density polyethylene (LDPE), linear low density polyethylene (LLDPE), functional polyolefin copolymers including polyolefin based ionomers, polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyvinyl alcohols, polyalkylene oxides, polyethers, water soluble polymers, polyacrylates, polymethacrylates, polyesters, polyvinylchloride (PVC), fluoropolymers, polyamides, polyacetals, polycarbonates, polyphenylene oxides, polyurethanes, thermoplastic elastomers (e.g., SIS, SEBS, SBS), silicones, or combinations thereof. Additives, such as those disclosed herein, may optionally be included as well.

The immiscible polymeric blend may contain between 1 to 49 volume % of an immiscible polymer matrix and at least 51 volume % of a soluble polymer matrix. In another embodiment, the immiscible polymeric blend may contain between 10 to 49 volume % of an immiscible polymer matrix and between 51 to 90 volume % of a soluble polymer matrix. In a yet another embodiment, the immiscible polymeric blend may contain between 25 to 49 volume % of an immiscible polymer matrix and between 51 to 75 volume % of a soluble polymer matrix.

A polymeric microparticle composition can also employ a variety of additives that can impart certain attributes and functionality to the resulting polymeric microparticle composition. Non-limiting examples of suitable additives include antioxidants, light stabilizers, fibers, blowing agents, foaming additives, anti-blocking agents, heat reflective materials, energy absorbers, heat stabilizers, impact modifiers, biocides, antimicrobial additives, compatibilizers, plasticizers, tackifiers, processing aids, lubricants, coupling agents, thermal conductors, electrical conductors, charge control agents, antistatic agents, catalysts, flame retardants, oxygen scavengers, fluorescent tags, inert fillers, minerals, and colorants. Additives may be incorporated into a polymeric microparticle composition in the form of powder, liquid, pellet, granule, or in any other extrudable form.

In one embodiment, the immiscible polymer matrix is first melt processed with the additives and subsequently melt processed with the soluble polymer matrix in a second step. The amount and type of conventional additives in a polymeric microparticle composition may vary depending upon the polymeric matrix and the desired properties of the finished composition. In view of this disclosure, persons having ordinary skill in the art will recognize that an additive and its amount can be selected in order to achieve desired properties in the finished material. Typical additive loading levels may be, for example, approximately 0.01 to 40 weight percent of the polymeric microparticle composition formulation.

A polymeric microparticle composition can also employ a variety of fillers that can impart certain attributes and functionality to the resulting polymeric microparticle composition. Non-limiting examples of fillers include mineral and organic fillers including carbonates, silicates, talc, mica, wollastonite, clay, silica, alumina, carbon fiber, carbon black, carbon nanotubes, graphite, graphene, volcanic ash, expanded volcanic ash, perlite, glass fiber, solid glass microspheres, hollow glass microspheres, cenospheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material. In view of this disclosure, persons having ordinary skill in the art will recognize the filler and its amount can be selected in order to achieve desired properties in the finished material. Typical filler loading levels may be, for example, approximately 1 to 60 weight percent of the polymeric microparticle composition formulation.

Polymeric microparticle compositions can be derived from an immiscible polymeric blend that includes one or more optional polymers to form polymeric microparticle compositions using the method herein described. Non-limiting examples of optional polymers that can be added to the immiscible polymeric blend include high density polyethylene (HDPE), low density polyethylene (LDPE), linear low density polyethylene (LLDPE), crosslinked polyethylene (PEX), vulcanized rubber, functional polyolefin copolymers including polyolefin based ionomers, polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyetheretherketones, polyketones, polyacetals, polycarbonates, polyphenylene oxides, polyurethanes, thermoplastic elastomers (e.g., SIS, SEBS, SBS), silicones, or combinations thereof.

Polymeric microparticle compositions, including any optional polymers and/or additives, can be prepared by melt processing. Depending on the selected soluble polymer matrix, this can be done using a variety of mixing processes known to those skilled in the art. The immiscible polymer matrix, soluble polymer matrix, and any optional polymers and/or additives can be combined together by any of the blending means usually employed in the plastics industry, such as with a compounding mill, a Banbury mixer, or a mixing extruder. In another embodiment, a vented twin screw extruder is utilized. The materials may be used in the form of, for example, a powder, a pellet, or a granular product. The mixing operation is most conveniently carried out at a temperature above the melting point or softening point of the immiscible polymer matrix and the soluble polymer matrix. The resulting melt-processed immiscible polymeric blend can be extruded directly into the form of the final product shape or fed from the melt processing equipment into a secondary operation to pelletize the composition (e.g., using a pellet mill or densifier) for later use.

In one embodiment, the melt rheology of the immiscible polymer matrix and the soluble polymer matrix of the immiscible polymeric blend are modified to increase or decrease the viscosity mismatch. Typically, increasing the viscosity mismatch results in larger particle size, while more closely matching the viscosity reduces particle size. In some embodiments, it is desirable to add viscosity modifiers or plasticizers to the immiscible polymer matrix and/or the soluble polymer matrix. Non-limiting examples of viscosity modifiers or plasticizers include low molecular weight organic oils, including mineral oil, polyethylene glycols, polypropylene glycols and glycerol. One skilled in the art can select the type and loading level of viscosity modifier or plasticizer to properly attenuate the viscosity of the system.

In another embodiment, interfacial modifiers can be added to the immiscible polymeric blend to either increase or reduce the surface tension between the immiscible polymer matrix and the soluble polymer matrix. Non-limiting examples of interfacial modifiers include functional polymers, surfactants, non-ionic surfactants, silanes, titanates, polysiloxanes, block copolymers, low molecular weight fluoropolymers, and amphiphilic polymers and copolymers.

In one embodiment, an organic solvent is utilized to dissolve and remove the soluble polymer matrix from the immiscible polymeric blend. Non-limiting examples of solvents useful in this disclosure include hexanes, toluene, xylene, ethyl acetate, alcohols (methanol, ethanol, isopropyl alcohol and longer chain alcohols), acetone, methyl ethyl ketone, mineral spirits and naphtha. In another embodiment, the soluble polymer matrix is soluble in water or water/alcohol combinations. In another embodiment, the soluble polymer matrix is soluble in an acidic or basic waterborne solution. Non-limiting examples of acids and bases that can be added to water to create the acidic or basic waterborne solution include: metal hydroxides (e.g., lithium, sodium, and potassium hydroxide), metal carbonates and bicarbonates (lithium, sodium and potassium carbonate or bicarbonate) and protonic acids (hydrochloric acid, hydrobromic acid, hydroiodic acid, hydrofluoric acid, sulfuric acid, nitric acid). In one embodiment, the soluble polymer matrix is chemically degraded when exposed to water or an acidic or basic waterborne solution. In one embodiment, the pH of the basic waterborne solution is greater than 10. In another embodiment, the pH of the acidic waterborne solution is less than 3. For example, if polylactic acid is the soluble polymer matrix, it can be chemically degraded when exposed to an basic waterborne solution, like potassium hydroxide wherein the pH of the solution is 10 or higher. In another embodiment, the soluble polymer matrix is soluble in supercritical fluids. Non-limiting examples of supercritical fluids include supercritical carbon dioxide, supercritical nitrogen, and supercritical water. In another embodiment, a cosolvent is added to the supercritical fluid to improve dissolution of the soluble polymer matrix. In one embodiment, a useful cosolvent is alcohol. In another embodiment, a useful cosolvent is water.

In one embodiment, the polymeric microparticle composition is isolated from the solvated soluble polymer matrix via gravity or settling. In another embodiment, the polymeric microparticle composition is isolated from the soluble polymer matrix by centrifugation. In another embodiment, the polymeric microparticle composition is isolated from the soluble polymer matrix via filtration. In one embodiment, the polymeric microparticle composition isolate is subsequently washed multiple times with a solvent. In yet another embodiment, the residual soluble polymer matrix in the polymeric microparticle composition is less than 0.1 weight percent. In some embodiments, the residual soluble polymer matrix in the polymeric microparticle composition is less than 0.01 weight percent.

In one embodiment, the isolated polymeric microparticle composition is dried at an elevated temperature to remove residual solvent. In another embodiment, the isolated polymeric microparticle composition is dried under vacuum. In another embodiment, the isolated polymeric microparticle composition is dried at an elevated temperature and under vacuum.

Polymeric microparticle compositions produced using this method have a number of advantages compared with polymeric microparticle compositions produced using methods known in the art. One key advantage is that the resulting particle size of the polymeric microparticle composition can be easily tailored between 1 micron to 100 microns. In another embodiment, the resulting particle size of the polymeric microparticle composition is between 5 microns to 100 microns. In yet another embodiment, the resulting particle size of the polymeric microparticle composition is between 10 microns to 100 microns. Another advantage is that the particle size distribution can be controlled. Another advantage is that the method can be used to produce a spherical microparticle morphology, wherein the length:diameter ratio is less than 2:1.

The disclosed polymeric microparticle composition can undergo additional processing for desired end-use applications.

In one embodiment of this disclosure, the immiscible polymer matrix and soluble polymer matrix are processed above their melt processing temperatures and the resulting mixture is quenched during processing to create a non-equilibrium microparticle morphology. In one embodiment, the number average particle size of polymeric microparticle compositions derived from the immiscible polymeric blend is between 0.1 nanometers to 100 microns. In another embodiment, the number average particle size of the polymeric microparticle composition is between 1 to 75 microns. In yet another embodiment, the number average particle size of the polymeric microparticle composition is between 5 to 50 microns. In one embodiment, the average length to diameter ratio (L:D) of the polymeric microparticle composition is less than 2:1. In another embodiment, the average L:D of the polymeric microparticle composition is less than 1.5:1. In yet another embodiment, the average L:D of the polymeric microparticle composition is less than 1.25:1.

The disclosed compositions and articles have broad utility in a number of industries, including, but not limited to, additive manufacturing, adhesives, coatings, films and cosmetics.

Polymeric microparticle compositions can be added into extruded thermoplastic film formulations to impart certain optical (e.g., light diffusion or pigmentation) properties. Polymeric microparticle compositions can also be added into extruded thermoplastic film formulations to act as an anti-blocking agent, reducing the adhesion force between film layers and making it easier to unwind.

Polymeric microparticle compositions can be added into paints and coatings to provide a variety of attributes. Non-limiting examples of desirable attributes include color/pigmentation, matte surface finish, antimicrobial activity, antigraffti performance, anti-scratch and mar performance, increased or reduced coefficient of friction.

Polymeric microparticle compositions can be added to cosmetic formulations to impart a variety of functionality. Non-limiting examples include: improved ease/uniformity of application, improved touch/feel, increased moisture retention, antimicrobial activity, and color/pigmentation.

Polymeric microparticle compositions can be used as a feedstock in additive manufacturing processes including selective laser sintering (SLS) and selective toner electrophotography (STEP). In SLS processes, the preferred microparticle morphology is spherical and the preferred number average particle size is approximately 50 microns. Polymeric microparticle compositions that are useful as SLS feedstock may also include additives to impart color or to improve heat management during the laser sintering process. Polymeric microparticle compositions that are useful in additive manufacturing processes may also include fine inorganic powders to reduce blocking and improve flowability during processing. In another embodiment, an energy absorbing additive is added to a polymeric microparticle composition so that the SLS laser efficiently transfers energy in order to melt the SLS feedstock. In one embodiment, the energy absorbing additive absorbs energy at wavelengths 200 nm and 1 mm. In another embodiment, the energy absorbing additive absorbs energy at infrared wavelengths between 780 nm and 1 mm. Non-limiting examples of energy absorbing additives include carbon black, graphite, cyanines, aminium salts and methal dithiolenes.

In the following examples, all parts and percentages are by weight unless otherwise indicated.

### EXAMPLES

TABLE 1
MATERIALS

| Material | Description & Supplier |
|---|---|
| Soluble Polymer | Kraton MD1648 polystyrene-ethylene/ |
| Matrix 1 | butylene-styrene (SEBS) block |
| (SPM1) | copolymer, commercially available |
| | from Kraton Inc. (Houston, TX) |
| Soluble Polymer | Ingeo 3001D PLA a polylactic acid |
| Matrix 2 | product, commercially |
| (SPM2) | available from NatureWorks ® LLC |
| | (Minnetonka, Minnesota) |
| Soluble Polymer | Tarflon ™ LC1500 polycarbonate, |
| Matrix 3 | commercially available from |
| (SPM3) | Chase Plastics Service, Inc. |
| | (Clarkston, Michigan) |
| Immiscible Polymer | Rilsan ® Clear G850 Rnew polyamide 11, |
| Matrix 1 (IPM1) | commercially available from Arkema S.A. |
| | (Colombes, France) |
| Immiscible Polymer | Tritan ® MX711 copolyester, commercially |
| Matrix 2 (IPM2) | available from Eastman Chemical |
| | Company (Kingsport, Tennessee) |
| Immiscible Polymer | Bapolene ® 4082NA polypropylene |
| Matrix 3 (IPM3) | homopolymer, commercially available from |
| | Bamberger Polymers, Inc. (Itasca, Illinois) |
| Immiscible Polymer | Solarkote ® H300 polymethyl methacrylate |
| Matrix 4 (IPM4) | (PMMA), commercially available from |
| | Arkema S.A. (Colombes, France) |
| Immiscible Polymer | KetaSpire ® KT-880 polyetheretherketone, |
| Matrix 5 (IPM5) | commercially available from Solvay |
| | Specialty Polymers (Alpharetta, Georgia) |
| Immiscible Polymer | Aquasys ® 120 water soluble polymer, |
| Matrix 6 (IPM6) | commercially available from Infinite |
| | Material Solutions, LLC (Prescott, WI) |
| Viscosity Modifier 1 | Mineral Oil, commercially available from |
| (VM1) | Brenntag Inc. (Toronto, ON) |

TABLE 2
EXPERIMENTAL FORMULATIONS

| Formulation | SPM1 | SPM2 | SPM3 | IPM1 | IPM2 | IPM3 | IPM4 | IPM5 | IPM6 | VM1 |
|---|---|---|---|---|---|---|---|---|---|---|
| 1 | 70% | | | 30% | | | | | | |
| 2 | 60% | | | 40% | | | | | | |
| 3 | 40% | | | | 50% | | | | | 10% |
| 4 | | 60% | | | | 40% | | | | |
| 5 | 70% | | | | | | 30% | | | |
| 6 | | | 70% | | | | | 30% | | |
| 7 | 70% | | | | | | | | 30% | |

TABLE 3
EXPERIMENTAL CONDITIONS

| | | | | | | Screw |
|---|---|---|---|---|---|---|
| | | Temperature Profile | | | Output | Speed |
| Formulation | Throat | Z2-Z8 | Z9-Z13 | Die | Rate | (rpm) |
| 1 | 100° C. | 300° C. | 300° C. | 300° C. | 30 lbs/hr | 350 |
| 2 | 105° C. | 300° C. | 300° C. | 250° C. | 60 lbs/hr | 450 |
| 3 | 120° C. | 250° C. | 250° C. | 250° C. | 60 lbs/hr | 400 |
| 4 | 100° C. | 270° C. | 270° C. | 270° C. | 60 lbs/hr | 200 |
| 5 | 105° C. | 260° C. | 260° C. | 250° C. | 30 lbs/hr | 500 |
| 6 | 20° C. | 375° C. | NA | 375° C. | 15 g/min | 100 |
| 7 | 20° C. | 215° C. | NA | 215° C. | 10 g/min | 160 |

### Sample Preparation: Formulations 1-7

Each of Formulations 1-7 was prepared according to the weight ratios in Table 2. Formulations 1-5 were gravimetrically fed into a 27 mm co-rotating twin screw extruder (52:1 L:D, commercially available from Entek Manufacturing LLC., Lebanon, Oregon). Formulations 6-7 were first blended in a plastic bag and gravimetrically fed into an 11 mm twin screw extruder (40:1 L:D, commercially available from ThermoFisher). Compounding was performed following the experimental conditions in Table 3. Formulations 1-5 were then extruded onto a conveyor belt, water cooled, air dried, and pelletized. Formulations 6-7 were extruded directly into a cool water bath, air dried and pelletized. The following are examples of the procedure for isolating the microparticles form the respective formulation blends.

Formulation 1 Procedure: 200 g of Formulation 1 pellets was place in a 1-qt glass jar to which was added 700 mL toluene (3.5 times the sample mass (g) in milliliters). The jar was capped and placed on a shaker table for 12 hours. The jar was removed from the shker table and positioned upright for 12-24 hours to allow the microparticles to settle to the bottom of the jar. After settling, the supernatant was removed and the microparticle layer diluted with more solvent and transferred to a 500 mL centrifuge bottle to which was added a total of 350 mL of toluene. The bottle was capped and centrifuged at 3400 rpm for 5 minutes. The solvent was decanted, and the process was repeated three times. The resulting polyamide microparticles were isolated after drying for 24 hours at room temperature in a fume hood and then 4-12 additional hours at 55° C.

Formulation 2 Procedure: Formulation 2 polyamide microparticles were isolated using the same procedure as Formulation 1.

Formulation 3 Procedure: Formulation 3 copolyester microparticles were isolated using the same procedure as Formulation 1 except that VM&P Naphtha (Sunnyside Corporation, Wheeling, Illinois) was used as the solvent in place of toluene.

Formulation 4 Procedure: 200 g of Formulation 4 pellets were placed in 2.0 L reaction vessel fitted with a Teflon coated mechanical stirrer and a heating jacket. To the pellets was added 1.66 L of a 4.0 M aqueous solution of sodium hydroxide (NaOH, 4 times the moles of lactic acid in the PLA) and the mixture was stirred and heated to 60-80° C. for 12-24 hours. After the PLA saponification was complete, the stirring was stopped and the polypropylene microparticles were allowed to float to the top. The aqueous layer was removed, distilled water (1.0 L) was added, and the mixture stirred for −1 hour. The stirring was stopped and the polypropylene microparticles were allowed to float to the top and the aqueous layer was removed. The washing process with distilled water was repeated 4 more times and the aqueous phase pH was <8.0. The polypropylene microparticles were isolated, dried at room temperature for 12 hours, and then dried at 55° C. for 24 hours.

Formulation 5 Procedure: Formulation 5 polymethyl methacrylate microparticles were isolated using the same procedure as Formulation 3.

Formulation 6 Procedure: Formulation 6 polyetheretherketone microparticles were isolated using the same procedure as Formulation 1 except that a mixture (˜4:1, v/v) methylene chloride: tetrahydrofuran (both available from MilliporeSigma, St. Louis, Missouri) was used as the solvent in place of toluene.

Formulation 7 Procedure: Formulation 7 water soluble microparticles were isolated using the same procedure as Formulation 1.

### Particle Characterization: Formulations 1-7

For each polymeric microparticle composition formulation 1-7, particle size analysis was performed using a LS 13 320 laser diffraction particle size analyzer (PSA), commercially available from Beckman Coulter Inc. (Brea, California). The PSA results are provided in Table 4.

TABLE 4
PARTICLE SIZE ANALYSIS RESULTS

| | Mean | Median | Mode | S.D. | d10 | d50 | d90 |
|---|---|---|---|---|---|---|---|
| Formulation | (μm) | (μm) | (μm) | (μm) | (μm) | (μm) | (μm) |
| 1 | 30.5 | 30.8 | 34.6 | 13.2 | 12.2 | 30.8 | 47.3 |
| 2 | 23.0 | 21.1 | 21.7 | 15.1 | 12.1 | 21.1 | 31.9 |
| 3 | 53.4 | 51.9 | 60.5 | 34.0 | 6.0 | 51.9 | 91.6 |
| 4 | 58.5 | 50.7 | 55.1 | 40.0 | 29.6 | 50.7 | 75.7 |
| 5 | 11.5 | 11.4 | 12.4 | 2.0 | 8.8 | 11.4 | 14.5 |
| 6 | 17.2 | 10.5 | 11.3 | 25.8 | 3.4 | 10.5 | 32.0 |
| 7 | 5.12 | 3.66 | 5.36 | 3.4 | 0.664 | 3.66 | 11.0 |

Having thus described particular embodiments, those of skill in the art will readily appreciate that the teachings found herein may be applied to yet other embodiments within the scope of the claims hereto attached.

What is claimed is:

1. A method for producing a polymeric microparticle composition comprising:
a) melt processing an immiscible polymeric blend comprising an immiscible polymer matrix and a soluble polymer matrix;
b) dissolving the soluble polymer matrix of the immiscible polymeric blend using a solvent to yield the polymeric microparticle composition; and
c) isolating the polymeric microparticle composition;
wherein the polymeric microparticle composition has a number average particle size between 1 micron and 100 microns.

2. The method of claim 1, further comprising the step of drying the polymeric microparticle composition.

3. The method of claim 1, wherein the polymeric microparticle composition has a number average particle size between 5 microns and 100 microns.

4. The method of claim 1, wherein the polymeric microparticle composition has a number average particle size between 10 microns and 100 microns.

5. The method of claim 1 or 2, wherein the polymeric microparticle composition has a spherical microparticle morphology with an average aspect ratio of less than 2:1, length: diameter.

6. The method of claim 1 or 2, wherein the polymeric microparticle composition has a spherical microparticle morphology with an average aspect ratio of less than 1.5:1, length: diameter.

7. The method of claim 1 or 2, wherein the polymeric microparticle composition has a spherical microparticle morphology with an average aspect ratio of less than 1.25:1, length: diameter.

8. The method of claim 1, wherein the solvent used to dissolve or chemically degrade the soluble polymer matrix is an organic solvent.

9. The method of claim 1, wherein the solvent used to dissolve or chemically degrade the soluble polymer matrix is water.

10. The method of claim 1, wherein the solvent used to dissolve or chemically degrade the soluble polymer matrix is a waterborne acid or base.

11. The method of claim 1 or 2, further comprising additives to impart additional functionality.

12. The method of claim 11, wherein the additives impart one or more of the following properties: UV stability, color, electrical conductivity, antimicrobial activity, mold and mildew resistance, rheological modification, moisture absorption, antistatic, energy absorbing, antigraffitti, low surface energy, optical effects, biodegradation, mechanical properties, thermal properties, or chemical resistance.

13. An article produced using feedstock derived from the method of claim 1 using an additive manufacturing process.

14. An article produced from the method of claim 1 that has application as an additive for plastics, coatings, adhesives, paints and cosmetics.
